(19) United States
(12) Patent Application Publication
(10) Pub. No.: US 2002/0041064 A1
(43) Pub. Date: Apr. 11, 2002

(54) Bushing type mount

(76) Inventors: Syunichi Shinobu, Osaka (JP); Nobuyuki Tamura, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/964,663

(22) Filed: Sep. 28, 2001

(30) Foreign Application Priority Data
Oct. 10, 2000 (JP) 2000-308743

(51) Int. Cl. F16F 5/00

(52) U.S. Cl. 267/140.11; 267/136

(57) ABSTRACT

A bushing type mount comprising an inner cylinder, an outer cylinder and a rubber-like elastomer interposed between the both cylinders, the outer cylinder being, at axially one extremity side, bent inwardly to form an inner flange, the inner flange being inclined at an intersecting angle made by its flange plane and the axial line of the inner cylinder of 60 to 85 degree, whereby it is possible to reduce a difference between a compressive deformation strain of the elastomer due to the inner flange and a shearing deformation strain occurring around the inner cylinder inboard of the inner flange and to suppress the occurrence of cracking to the utmost, thus enhancing the durability.

### BACKGROUND OF THE INVENTION

1. Field of the Invention

This invention relates to a bushing type mount to be fitted to a suspension member or the like thereby bearing a component to be supported in a vibration-absorbing manner.

2. Description of Related Art

As a bushing type mount of this kind, in the state of the art there exist so-called diff. mounts for bearing a differential gear mechanism on the rear wheels side of a rear-wheels driven vehicle to a suspension member or the like in a vibration absorbing manner. Of the diff. mounts such one is, for example, known that is comprised of an inner cylinder attached to the member side, an outer cylinder disposed around the inner cylinder so as to be attached to a component to be supported and a rubber-like elastomer interposed between the inner and outer cylinders, the outer cylinder being formed at its lower extremity with an inner flange bent inwardly in the axially square direction.

With the diff. mount as constructed above, when it is installed with the axial line of the inner cylinder conformed to the vertical direction of the vehicle, vibrations input from the differential gear side are absorbed and damped by a shearing deformation of the rubber-like elastomer interposed between the inner and outer cylinders so as to insulate the vibrations from being transmitted to the vehicle body side. On the other hand, the inner flange formed at the lower side of the outer cylinder permits to enhance the spring rate in the vertical direction and to support the vertical force of the vehicle, too.

As stated above, the rubber-like elastomer in the existing diff. mount mentioned above cooperates with the inner flange of the outer cylinder so as to support the vertical force of the vehicle by its compressive deformation. Concurrently with this, the rubber-like elastomer also exists between the inner flange and the inner cylinder and, in case where vibrations in the vertical direction are input, still undergoes inevitably a shearing deformation.

Because of the construction above, the existing mount was problematic from the aspect of durability in that when repeated stresses in the vertical direction mainly act on it, a strain difference at the boundary between a portion of the rubber-like elastomer subjected to a compressive deformation and another portion of the rubber-like elastomer subjected to a shearing deformation becomes larger, and cracks are produced from the juncture of the inner end of the inner flange and the rubber-like elastomer, which corresponds to the boundary.

In view of the problems stated above, the present inventors have pursued intensively a countermeasure for precluding the occurrence of cracking at the juncture between the inside end of the inner flange and the rubber-like elastomer as far as possible, and as a result, found out that when an inclined plane is formed so that the juncture escapes to the utmost toward axially outer end side, a stress concentration on the juncture is alleviated and the occurrence of cracking is suppressed to the utmost, which has come to this invention.

Accordingly, a principal object of this invention is to provide a bushing type mount such that ,even if vertical stresses repeatedly act on it, can preclude the occurrence of cracking from the juncture between the inside end of the inner flange and the rubber-like elastomer and is superior in durability. Another object is to enable the aforementioned mount superior in durability to be produced easily.

### SUMMARY OF THE INVENTION

The bushing type mount, with which the invention is concerned, comprises an inner cylinder adapted to be attached to the member side, an outer cylinder arranged in the surroundings of the inner cylinder so as to be attached to a component side to be supported, and a rubber-like elastomer interposed between the inner and outer cylinders, the outer cylinder being at axially one extremity bent inwardly in an axially square direction to form an inner flange, and is characterized in that the inner flange has a flange plane inclined toward the axially outer end side.

According to this construction, when the inner flange of the outer cylinder has the flange plane inclined toward the axially outer end side, a difference between a compressive deformation strain of the rubber-like elastomer due to the inner flange and a shearing deformation strain occurring around the inner cylinder inboard it is to be reduced, and even if repeated stresses act, the occurrence of cracking is to be suppressed to the utmost.

The bushing type mount pertaining to this invention, in addition to the aforementioned construction, is further characterized that the inner flange of the outer cylinder is made such an inclined plane that the intersecting angle made by the flange plane and the axial line of the inner cylinder is 60 to 85 degree.

Here, the reason why the intersecting angle made by the flange plane of the inner flange and the axial line of the inner cylinder is set 60 to 85 degree is that if the intersecting angle is less than 60 degree, the spring rate of the rubber-like elastomer in the vertical direction (axial direction) is too small to obtain a required supporting force whereas if it is more than 85 degree, cracking is likely to occur.

For the formation of the inclined plane of the inner flange, an approach of setting from the forming of the outer cylinder is conceivable. Yet aside from this, if in forming the outer cylinder, the inner flange is formed by bending at 90 degree relative to the axial line of the outer cylinder and after the vulcanization molding of the rubber-like elastomer and the outer cylinder, the outer cylinder undergoes drawing working in axially square direction, thus reducing the diameter, whereby the inner flange is made to be shifted axially outwardly, taking advantage of the phenomenon that the inner flange thus bent cannot follow the drawing working, but is elongated, then it is also possible to perform the working process simply.

That is, the invention further provides a bushing type mount which is produced by, after vulcanization molding of the inner and outer cylinders and the rubber-like elastomer in the state that the inner flange is bent at 90 degree to the axial line of the outer cylinder, submitting the outer cylinder to drawing working in axially square direction to reduce its diameter.

The abovementioned mount whose inner flange is inclined is also applicable to a bushing type mount having an intermediate projecting portion jutting out in axially square direction from an axially intermediate position of the inner cylinder, for example, also taking account of the spring characteristics in a prying direction (axially tilting direction).

The bushing type mount relative to this invention is characterized in that the inner cylinder has an intermediate projecting portion jutting out axially squarely from the axially intermediate position thereof, the intermediate projecting portion being embedded in the rubber-like elastomer, and an outside diameter of the intermediate projecting portion is set larger than an inside diameter of the inner flange. By this constitution, it is possible to achieve desired spring characteristics also in the prying direction.

The relation between the outside diameter of the intermediate projecting portion and the inside diameter of the inner flange in this kind of bushing type mount is not particularly limited, yet if the outside diameter of the intermediate projecting portion is set larger than the inside diameter of the inner flange, it is possible to prevent cracking from occurring.

Stated another way, the bushing type mount of this invention is characterized in that the intermediate projecting portion of the inner cylinder, which juts out axially squarely from the axially intermediate position thereof, is embedded in the rubber-like elastomer and that the outside diameter of the intermedate projecting portion is set larger than the inside diameter of the inner flange.

According to this construction, against the input of axial vibrations, a compressive stress acts on the rubber-like elastomer interposed between the intermediate projecting portion and the inner flange and consequently, it is possible to sustain a large force from the axial direction and concurrently, to preclude the occurrence of cracking because a shearing stress hardly acts.

Furthermore, in the aforementioned bushing type mount, the rubber-like elastomer may be defined at its axially one extremity or both etremities with a hollow or recess portion(s). That is, the bushing type mount pertaining to this invention is characterized in that a recess is formed in one axial extremity of the rubber-like elastomer so as to extend adjacent to and radially inwardly of the inner flange over the entire circumference of the inner cylinder.

According to this construction, by the formation of the recess it is possible to adjust easily the spring rates in the axial direction and axially square direction.

### BRIEF DESCRIPTION OF THE DRAWINGS

FIG. 1 is an illustration showing a bushing type mount relating to this invention in its installed state;

FIG. 2 is a plan view of a bushing type mount (diff. mount) relating to this invention;

FIG. 3 is a sectional view of the diff. mount showing its installed state; and

FIG. 4A and FIG. 4B are a sectional view of the diff. mount upon vulcanization molding and a similar sectional view after drawing working, respectively.

### DESCRIPTION OF THE PREFERRED EMBODIMENTS

The invention will be hereinafter described in more detail by way of examples with reference to the accompanying drawings.

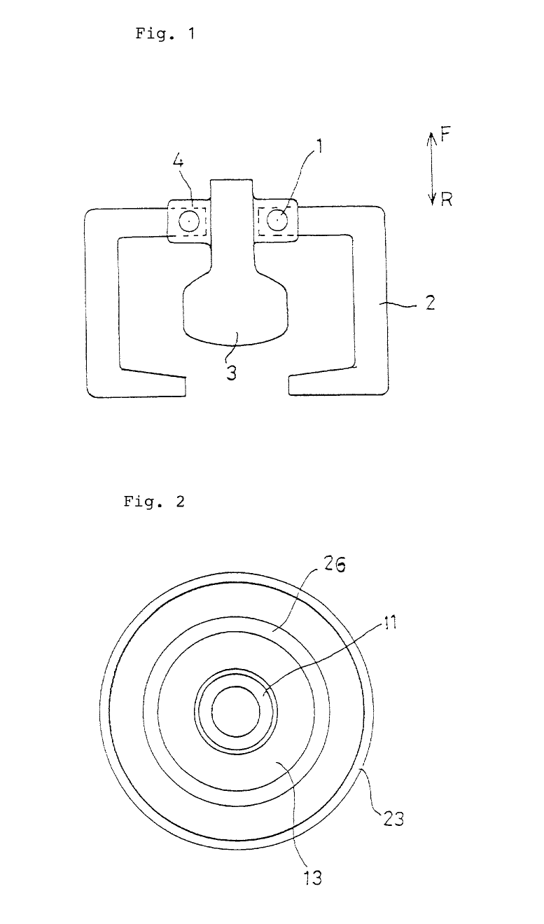

As showin in FIG. 1, a bushing type mount 1 of this invention (diff. mount) serves to support and bear a differential gear 3 on the rear wheels side from both sides of rear frame members 2 of a rear wheels-driven vehicle.

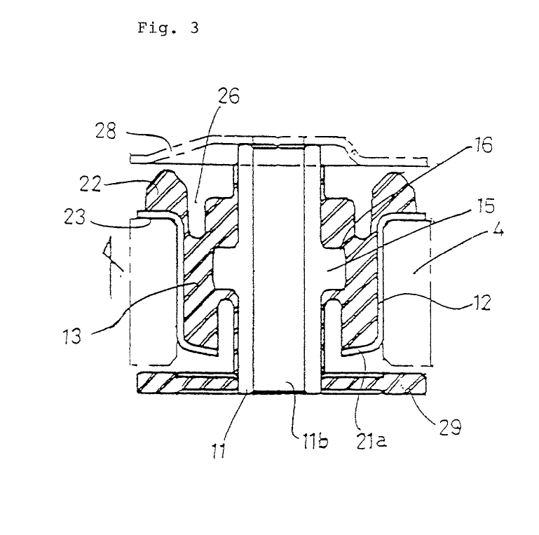

The bushing type mount 1 is, as shown in FIGS. 2 and 3, provided with an inner cylinder 11 adapted to be attached to the rear frame member 2 side, an outer cylinder 12 disposed concentrically around the inner cylinder 11 to be attached to an opening of a differential gear bracket 4 by press fitting, and a rubber-like elastomer 13 interposed between the inner cylinder 11 and the outer cylinder 12.

The inner cylinder 11 is a cylindrical metal component, from whose axially intermediate position, an intermediate projecting portion 15 juts out axially squarely. In order to adjust a spring rate in the prying direction, the intermediate projecting portion 15 is either formed integrally on the outer peripheral surface of the inner cylinder or constructed of a ring-form component, to which a component of rigid resin or metal, e.g. aluminum, iron is connected firmly.

The outside diameter of the intermediate projecting portion 15 is set to be larger than the inside diameter of an inner flange 21, which will be described below, of the outer cylinder 12 so that compressive and tensile stresses in the vertical direction (axial direction) may act on the rubber-like elastomer interposed between the intermediate projecting portion 15 and the inner flange 21. More specifically, the intermediate projecting portion 15 is set to have an outside diameter of 25˜40 mm, more preferably 30˜34 mm and a thickness of 4˜16 mm, more preferably 8˜12 mm. The intermediate projecting portion 15 is profiled at its outer circumferential edge surface with a slight radiused surface 16 so that the joint surface with the rubber-like elastomer 13 may be smoothed.

The outer cylinder 12 must have a rigidity to the extent that the inner flange 21 is deformed when subjected to a stress due to drawing working. To that end, the outer cylinder 12 is constructed as a cylindrical component of steel plate having a thickness of 1 to 2 mm, more prefererabl 1.4 to 1.8 mm. And one axial extremity (the lower end side) of the outer cylinder 12 is bent inwardly in the axially square direction to form the ring-form inner flange 21 whereas the other axial extremity (the upper end side) is bent outwardly to form a ring-form outer flange 23 for vulcanization bonding a stopper rubber 22 thereto.

The inner flange 21 has a flange plane 21a inclined in a manner being directed toward the axially outer extremity side. The flange plane 21a is set as an inclined plane so that an intersecting angle θ made by an elongated plane of the flange plane and an axial line 11a of the inner cylinder 11 is 60 to 85 degree, more preferably 75 to 80 degree, whereby any cracking from the joint surface with the rubber-like elastomer 13 is prevented.

The inclined plane of the inner flange 21 is configured in such a procedure that upon forming of the outer cylinder 12, the inner flange 21 is formed by bending the outer cylinder 12 at 90 degree relative to the axial line of the outer cylinder 12 (the same as the axial line of the inner cylinder 11), the rubber-like elastomer 13 is vulcanization-molded with the inner and outer cylinders 11, 12, and then, the outer cylinder 12 is subjected to drawing working in axially square direction to reduce the diameter, thereby moving the inner flange 21 axially outwardly owing to the axial movement stress of the rubber-like elastomer 13. Here it is possible to form the inclined plane by setting a drawing rate of the straight tube portion 12a of the outer cylinder 12 in the range of 5 to 30%, more preferably 8 to 13%.

The rubber-like elastomer 13 may be of every kind of rubber, irrrespective of natural or synthetic or even a resin elastomer, and is molded by vulcanization, interposed between the inner and outer cylinders 11, 12. At one axial extremity surface (lateral side of the lower end) of the rubber-like elastomer 13 there is formed a first recess 25 in the entire periphery of the inner cylinder 11 located adjacent to and radially inwardly of the inner flange 21.

The first recess 25 must be formed on the inner cylinder side of the inner flange 21 from the position relation with the inner flange. Here, since the first recess 25 is formed adjacent to the inner flange 21, mainly a compressive deformation only acts on the joint part of the inner end of the inner flange 21 with the rubber-like elastomer 13 and shearing deformation little occurs, so that the occurrence of cracking can be advantageously obviated.

On the other hand, at the other axial extremity surface (lateral side of the upper end) a second recess 26 is formed to extend radially outboard of the intermediate projecting portion over the entire periphery around the inner cylinder.

The recesses 25, 26 are each set to be 2˜6 mm wide (more preferably 3˜5 mm) and 5˜15 mm deep axially (more preferably 8˜12 mm). The recesses 25, 26 may be formed either partially or wholly around the periphery of the inner cylinder.

At the rubber-like elastomer 13, a stopper rubber 22 is further bonded by vulcanization to the top surface of the outer flange 23, extending adjacent to the rubber portion outboard of the second recess 26. The stopper rubber 22 projects axially outwardly and serves to impinge on an attachment plate 28 of the frame member side upon axial inputting, thus mitigating the shock.

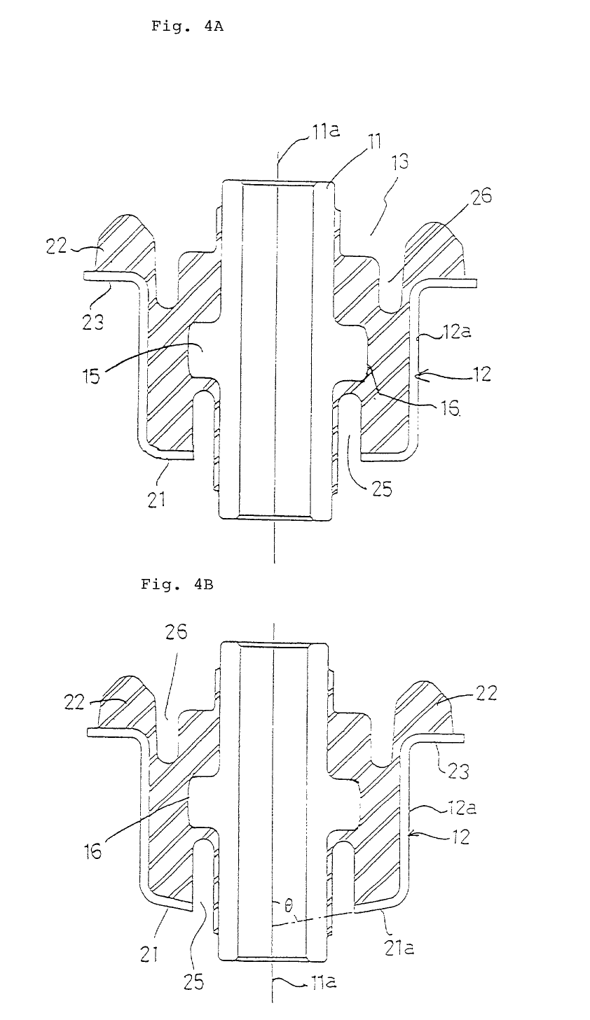

The diff. mount 1 as constructed above is fabricated as follows: As shown in FIG. 4A, the inner flange 21 is formed by bending the outer cylinder 12 at 90 degree to the axial line, then the inner and outer cylinders 11, 12 and the rubber-like elastomer 13 are bonded by vulcanization, and subsequently, as shown in FIG. 4B, the outer cylinder 12 is subjected to drawing working to reduce the diameter. Thereby the inner flange 21 is moved axially outwardly owing to the axial movement stress of the rubber-like elastomer 13 to form the inclined plane, and the mount is thus completed.

The diff. mount 1 so completed is used, as shown in FIG. 3, to support the differential gear 3 to the frame member 2 in a manner that the outer cylinder 12 is press fitted into the opening of the differential bracket 4 from axially upwardly, a ring-form stopper rubber plate 29 is fitted around the lower end of the inner cylinder 11, thereafter the attachment plate 28 is fitted onto the inner plate 11 from upwardly, and a bolt is inserted into a central hole 11b of the inner cylinder 11 thereby to fasten thereto.

With this diff. mount 1, on account of the particular construction that the inner flange 21 at the lower side of the outer flange 12 is inclined, the rubber-like elastomer 13 interposed between the inner flange 21 and the intermediate projecting portion 15 is alleviated in compressive stress and its durability is enhanced to that extent.

The diff. mout 1 according to the embodiment described above was subjected to a durability testing by field running in comparison to a comparative diff. mount, whose inner flange was bent axially squarely. As a result, after 100,000 km running, the comparative diff. mount caused cracking at the inner end of the inner flange whilst the diff. mount 1 of this embodiment never caused cracking at the rubber part.

This invention is not contemplated to be limited to the aforementioned embodiment, but it should be appreciated that it is possible to modify and alter the invention without deviating from the scope and spirit of this invention. For example, although the construction that, the ring-form intermediate projecting portion is arranged in the entire circumference of the inner cylinder is exemplified in the foregoing embodiment, such a variation is also possible that the intermediate projecting portion is arranged partly around the circumference of the inner cylinder. Furthermore with a view to precluding the occurrence of cracking of the rubber-like elastomer, aside from the means of inclining the inner flange of the outer cylinder as in the foregoing embodiment, another means of bending the inner end of the inner flange with its axially outer edge side radiused may be adopted singly or in combination with the aforementioned inclined plane.

What is claimed is:

1. A bushing type mount comprising an inner cylinder to be attached to a member side, an outer cylinder disposed in the surroundings of the inner cylinder so as to be attached to a component side to be supported, and a rubber-like elastomer interposed between the inner and outer cylinders, the outer cylinder being, at its axially one extremity side, bent inwardly in an axially square direction to form an inner flange, wherein the inner flange has a flange plane inclined toward an axially outer end side.

2. The bushing type mount as set forth in claim 1, wherein the inner flange is inclined so that its flange plane and an axial line of the inner cylinder make an intersecting angle of 60 to 85 degree.

3. The bushing type mount as set forth in claim 1, wherein after vulcanization molding of the inner and outer cylinders and the rubber-like elastomer while the inner flange is bent at 90 degree relative to the axial line of the outer cylinder, the inclined flange plane of the inner flange is formed by submitting the outer cylinder to drawing working in the axially square direction thereby to reduce its diameter.

4. The bushing type mount as set forth in claim 1, wherein the inner cylinder has an intermediate projecting portion jutting out axially squarely from its axially intermediate position and embedded in the rubber-like elastomer, and an outside diameter of the intermediate projecting portion is set to be larger than an inside diameter of the inner flange.

5. The bushing type mount as set forth in claim 2, wherein the inner cylinder has an intermediate projecting portion jutting out axially squarely from its axially intermediate position and embedded in the rubber-like elastomer, and an outside diameter of the intermediate projecting portion is set to be larger than an inside diameter of the inner flange.

6. The bushing type mount as set forth in claim 3, wherein the inner cylinder has an intermediate projecting portion jutting out axially squarely from its axially intermediate position to be embedded in the rubber-like elastomer, and an outside diameter of the intermediate projecting portion is set to be larger than an inside diameter of the inner flange.

7. The bushing type mount as set forth in claim 1, wherein the rubber-like elastomer is formed at its axially one extremity with a recess, the recess extending in an entire periphery of the surroundings of the inner cylinder radially inboard of and adjacent to the inner flange.

8. The bushing type mount as set forth in claim 2, wherein the rubber-like elastomer is formed at its axially one extremity with a recess, the recess extending in an entire periphery of the surroundings of the inner cylinder radially inboard of and adjacent to the inner flange.

9. The bushing type mount as set forth in claim 3, wherein the rubber-like elastomer is formed at its axially one extremity with a recess, the recess extending in an entire periphery of the surroundings of the inner cylinder radially inboard of and adjacent to the inner flange.

10. The bushing type mount as set forth in claim 4, wherein the rubber-like elastomer is formed at its axially one extremity with a recess, the recess extending in an entire periphery of the surroundings of the inner cylinder radially inboard of and adjacent to the inner flange.

11. The bushing type mount as set forth in claim 5, wherein the rubber-like elastomer is formed at its axially one extremity with a recess, the recess extending in an entire periphery of the surroundings of the inner cylinder radially inboard of and adjacent to the inner flange.

12. The bushing type mount as set forth in claim 6, wherein the rubber-like elastomer is formed at its axially one extremity with a recess, the recess extending in an entire periphery of the surroundings of the inner cylinder radially inboard of and adjacent to the inner flange.
